(19) United States
(12) Patent Application Publication
(10) Pub. No.: US 2009/0032491 A1
(43) Pub. Date: Feb. 5, 2009

(54) CONDUCTIVE ELEMENT FORMING USING SACRIFICIAL LAYER PATTERNED TO FORM DIELECTRIC LAYER

(75) Inventors: Veeraraghavan S. Basker, Yorktown Heights, NY (US); Steven J. Holmes, Guilderland, NY (US); David V. Horak, Essex Junction, VT (US); Muthumanickam Sankarapandian, Yorktown Heights, NY (US)

Correspondence Address: HOFFMAN WARNICK LLC, 75 STATE ST, 14TH FL, ALBANY, NY, 12207, US

(73) Assignee: INTERNATIONAL BUSINESS MACHINES CORPORATION, Armonk, NY (US)

(21) Appl. No.: 11/833,301

(22) Filed: Aug. 3, 2007

(51) Int. Cl. H01B 13/00; B32B 3/10

(52) U.S. Cl. 216/13; 428/131

(57) ABSTRACT

Methods of forming a conductive element for an integrated circuit (IC) chip and a related structure are disclosed. One embodiment of the method may include forming a first sacrificial layer having a pattern therein for a first dielectric layer to surround the conductive element; forming the first dielectric layer within the patterned first sacrificial layer; removing the patterned first sacrificial layer, leaving the first dielectric layer; and forming the conductive element in a space vacated by the patterned first sacrificial layer. The methods prevent damage caused to low dielectric constant dielectric layers during etching and stripping/cleaning processes.

### BACKGROUND

1. Technical Field

The disclosure relates generally to integrated circuit (IC) chip fabrication, and more particularly, to methods of forming a conductive element for an integrated circuit (IC) chip, and a related structure, using a sacrificial layer patterned to form the dielectric layer that surrounds the conductive element.

2. Background Art

Current metallization schemes for the wiring of integrated circuit (IC) chips involves the patterning and etching of a dielectric layer, followed by metal liner deposition and then the plating of copper into the spaces of the pattern. Chemical mechanical polish (CMP) is then used to planarize the structure. One problem with this method is that when low dielectric constant (low-k) dielectric materials are used, the processes for etching the dielectric, stripping the resist, and cleaning the dielectric surfaces can cause damage to the dielectric layer. One approach to address this problem has been to repair the damage by using silylation processes, but this approach has met with limited success.

### SUMMARY

Methods of forming a conductive element for an integrated circuit (IC) chip and a related structure are disclosed. One embodiment of the method may include forming a first sacrificial layer having a pattern therein for a first dielectric layer to surround the conductive element; forming the first dielectric layer within the patterned first sacrificial layer; removing the patterned first sacrificial layer, leaving the first dielectric layer; and forming the conductive element in a space vacated by the patterned first sacrificial layer. The methods prevent damage caused to low dielectric constant dielectric layers during etching and stripping/cleaning processes.

A first aspect of the disclosure provides a method of forming a conductive element for an integrated circuit (IC) chip, the method comprising: providing a device layer of the IC chip; forming a first sacrificial layer over the device layer; forming a first patterned mask on the first sacrificial layer having a pattern for a first dielectric layer to surround the conductive element; etching to pattern the first sacrificial layer using the first patterned mask; forming the first dielectric layer within the patterned first sacrificial layer; removing the patterned first sacrificial layer, leaving the first dielectric layer; and forming the conductive element in a space vacated by the patterned first sacrificial layer.

A second aspect of the disclosure provides a structure comprising: a conductive element positioned within a dielectric layer, wherein the dielectric layer is free of damage at an edge thereof adjacent to the conductive element.

A third aspect of the disclosure provides a method of forming a conductive element for an integrated circuit (IC) chip, the method comprising: forming a first sacrificial layer having a pattern therein for a first dielectric layer to surround the conductive element; forming the first dielectric layer within the patterned first sacrificial layer; removing the patterned first sacrificial layer, leaving the first dielectric layer; and forming the conductive element in a space vacated by the patterned first sacrificial layer.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIGS. 1-4 show one embodiment of a method of forming a conductive element for an integrated circuit (IC) chip according to the disclosure, with FIG. 4 showing one embodiment of a structure according to the disclosure.

FIGS. 5-12 show another embodiment of the method, with FIG. 12 showing another embodiment of the structure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

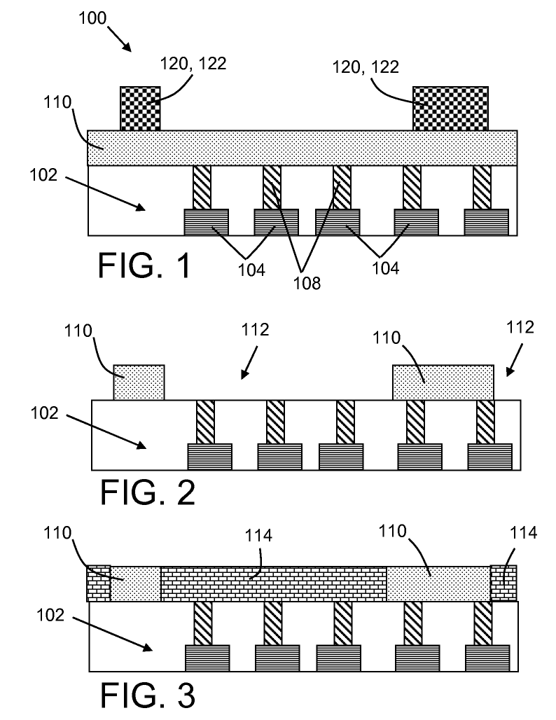

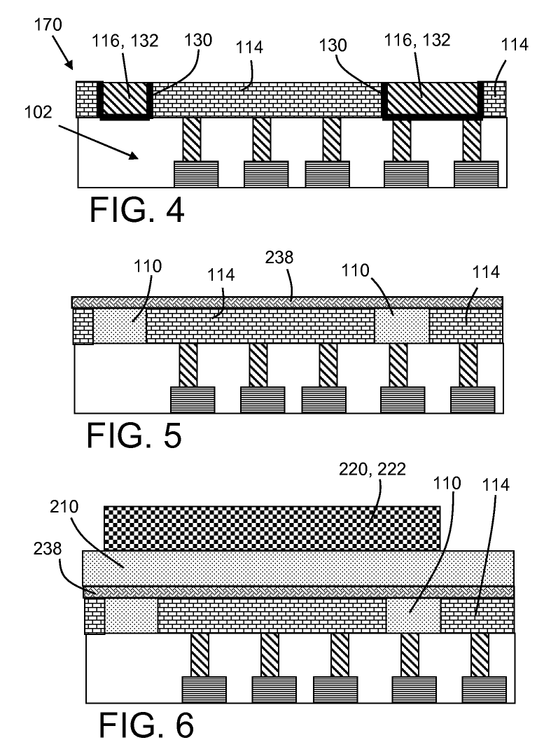

Referring to FIGS. 1-4, one embodiment of a method of forming a conductive element 116 (FIG. 4) for an integrated circuit (IC) chip is illustrated. In this embodiment, conductive element 116 includes a laterally extending wire or a via. In FIG. 1, a device layer 100 of IC chip 102 is provided, i.e., up to a first metallization layer. Device layer 102 may include a plurality of devices 104, e.g., transistors, middle of line connectors 108 and/or other well known structures, and may be formed using any now known or later developed techniques.

FIGS. 1-2 show forming a first sacrificial layer 110 having a pattern 112 therein for a first dielectric layer 114 (FIGS. 3-4) to surround conductive element 116 (FIG. 4). That is, first sacrificial layer 110 is formed with an inverse image for conductive element 116 such that first dielectric layer 114 is formed with pattern 112 that is inverse of a standard pattern for conductive element 116 therein. First dielectric layer 114 may be a spin coated or a vapor deposited low or ultra low or extreme low k dielectric constant (low-k or ULK or ELK) material made of organosilicate glass or carbon doped oxide films (hydrogenated silicon oxycarbide (SiCOH) or porous SiCOH) or silicon oxycarbide films or organic polymers or their porous films. Some examples are Black Diamond™ and Black Diamond II™ from Applied Materials, Nanoglass™ series (Honeywell Electronics), Nanoglass™ manufactured by Honeywell Microelectronic Materials Inc, Dendriglass™ which is a material developed by IBM Corporation, XLK dielectric from Dow Corning and LKD series (JSR Corporation).

As shown in FIG. 1, this process may include forming first sacrificial layer 110 by, for example, spin applying the first sacrificial layer and baking, or by vapor depositing the first sacrificial layer and annealing. Spin applying might be more favorable in some circumstances in order to enhance gap filling. First sacrificial layer 110 may be any material that is easily removed in the presence of a low dielectric constant (low-k) dielectric (114), and is compatible with standard lithography and etch processes used for patterning. In one embodiment, first sacrificial layer 110 may include silicon dioxide (SiO₂) (e.g., HARP available from Applied Materials), germano-silicate glass or germanium (Ge). If germano-silicate glass is used, it may have an approximately 50-60% germanium (Ge) ratio.

A first patterned mask 120 may then be formed on first sacrificial layer 110 by, for example, forming a photoresist 122, patterning photoresist 122 with a mask and exposure tool (not shown), etching photoresist 122, and stripping un-exposed photoresist, e.g., by using a conventional reaction ion etch (RIE) technique. FIG. 2 shows the result of etching to pattern first sacrificial layer 110 using first patterned mask 120, e.g., using a RIE technique.

FIG. 3 shows forming first dielectric layer 114 within patterned first sacrificial layer 110. As noted above, first dielectric layer 114 includes a low-k material such as spin coated or a vapor deposited low or ultra low or extreme low k dielectric constant (low-k or ULK or ELK) material made of organosilicate glass or carbon doped oxide films (SiCOH or PSiCOH) or silicon oxycarbide films or organic polymers or their porous films. Some examples are Black Diamond™ and Black Diamond II™ from Applied Materials, Nanoglass™ series (Honeywell Electronics), Nanoglass™ manufactured by Honeywell Microelectronic Materials Inc, Dendriglass™ which is a material developed by IBM Corporation, XLK dielectric from Dow Corning and LKD series (JSR Corporation). This process may include, for example, spin applying or vapor depositing first dielectric layer 114, annealing and planarizing, e.g., using chemical mechanical polishing. Other materials may use different processes.

FIG. 4 shows removing the patterned first sacrificial layer 110 (FIG. 3), leaving first dielectric layer 114. In one embodiment, where first sacrificial layer 110 includes silicon dioxide (SiO₂) or germano-silicate glass, the removing may include using a dilute hydrofluoric (HF) acid to remove layer 110. In another embodiment, where first sacrificial layer 110 includes germanium (Ge), the removing may include using a hydrogen peroxide (H₂O₂) solution to remove layer 110. Other materials and removal solutions may also be employed.

FIG. 4 also shows forming conductive element 116 in a space vacated by the patterned first sacrificial layer 110. This process may include any now known or later developed technique for forming a conductor. In one embodiment, this process may include depositing a liner 130, depositing a metal 132 (e.g., copper, aluminum), and planarizing, e.g., CMP. Liner 130 may include any typical liner material such as: titanium nitride (TiN), tantalum nitride (TaN), tantalum (Ta) or ruthenium (Ru).

Turning to FIGS. 5-12, another embodiment of a method of forming a conductive element 216 (FIG. 12) in which the element includes a via 240 and a laterally extending wire 242 (dual damascene) will now be described. In this embodiment, the processes of FIGS. 1-3 are repeated, but the patterned first sacrificial layer 110 (FIG. 5) is patterned for via 240 (FIG. 12) of conductive element 216 (FIG. 12), not a laterally extending wire. Hence, FIG. 5 shows smaller portions of first sacrificial layer 110 and larger portions of first dielectric layer 114 than FIG. 3.

In accordance with this embodiment, FIG. 5 also shows, prior to the patterned first sacrificial layer 110 removal, forming an etch stop layer 238 over the patterned first sacrificial layer 110 and first dielectric layer 114. Etch stop layer 238 may include, for example, a dissolvable silicon nitride (Si₃N₄) (e.g., NBlok).

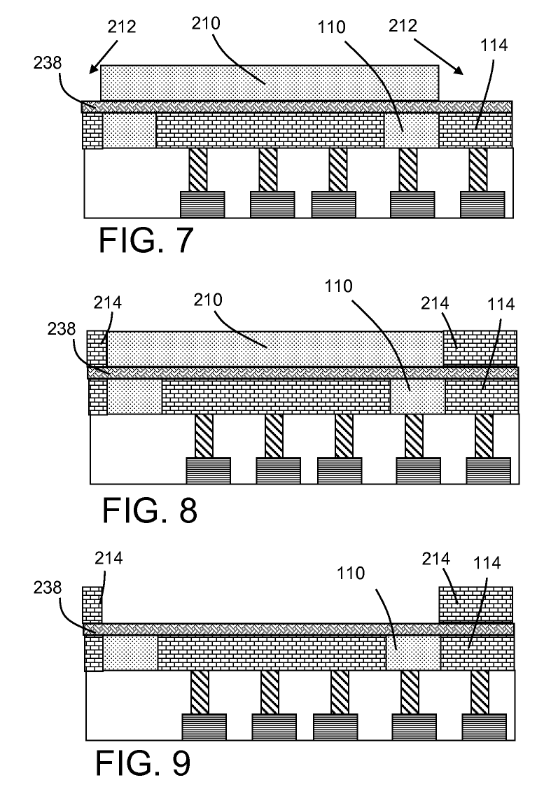

FIGS. 6-8 show forming a second sacrificial layer 210 having a pattern 212 (FIG. 7) therein for a second dielectric layer 214 (FIG. 8) to surround a wire 242 (FIG. 12) of conductive element 216 (FIG. 12). That is, second sacrificial layer 210 is formed with an inverse image for wire 242 (FIG. 12) of conductive element 216 such that second dielectric layer 214 is formed with pattern 212 that is inverse of a standard pattern for wire 242 (FIG. 12) of conductive element 216 (FIG. 12) therein. Second dielectric layer 214 may include any low dielectric constant (low-k) material listed above relative to first dielectric layer 114.

As shown in FIG. 6, this process may include forming second sacrificial layer 210 by, for example, spin applying the first sacrificial layer and baking, or by vapor depositing the first sacrificial layer and annealing. Spin applying might be more favorable in some circumstances in order to enhance gap filling. Second sacrificial layer 210 may include any of the materials listed above relative to first sacrificial layer 110.

A second patterned mask 220 may then be formed on second sacrificial layer 210 by, for example, forming a photoresist 222, patterning photoresist 222 with a mask and exposure tool (not shown), etching photoresist (pattern) 222, and stripping remaining photoresist, e.g., by using a conventional reaction ion etch (RIE) technique. FIG. 7 shows the result of etching to pattern first sacrificial layer 210 using first patterned mask 220, e.g., using a RIE technique.

FIG. 8 shows forming second dielectric layer 214 within the patterned second sacrificial layer 210. As noted above, second dielectric layer 214 may include any low-k material. This process may include, for example, spin applying or vapor depositing second dielectric layer 214, annealing and planarizing, e.g., using chemical mechanical polishing. Other low-k materials may use different processes.

FIG. 9 shows removing the patterned second sacrificial layer 210 (FIG. 8), leaving second dielectric layer 214. This process may include using any solution as described above relative to first sacrificial layer 110.

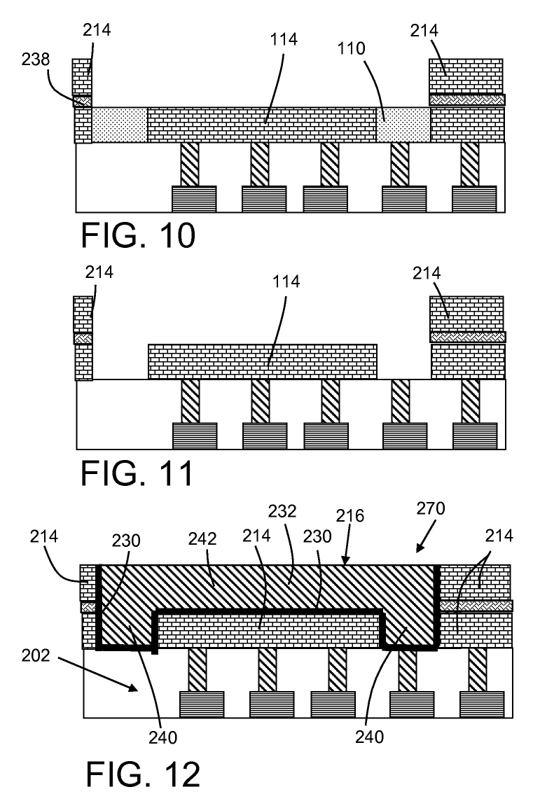

FIG. 10 shows removing etch stop layer (within opening), e.g., by a wet etch or RIE. This process exposes first sacrificial layer 110 and first dielectric layer 114.

FIG. 11 shows removing first sacrificial layer 110, leaving first dielectric layer 114. This process may include using any solution as described above relative to first sacrificial layer 110.

FIG. 12 shows forming conductive element 216. In this embodiment, this process includes forming conductive element 216 in a space vacated by the patterned first sacrificial layer 110, i.e., via 240, and forming further includes forming conductive element 216 in a space vacated by the patterned second sacrificial layer 214, i.e., laterally extending wire 242. This process may include any now known or alter developed technique for forming a conductor such as that described above relative to conductor 116 (FIG. 4).

FIGS. 4 and 12 respectively show a structure 170, 270 including a conductive element 116, 216 positioned within a dielectric layer 114, 214, where the dielectric layer is free of damage at an edge thereof adjacent to the conductive element. In particular, the above-described processes avoid causing damage to low-k dielectric layers 114, 214 caused by RIE and/or stripping/cleaning processes such that no damage is present because the low-K dielectrics are only introduced after these other processes are completed.

The methods and structure as described above are used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to a person skilled in the art are intended to be included within the scope of the disclosure as defined by the accompanying claims.

What is claimed is:

1. A method of forming a conductive element for an integrated circuit (IC) chip, the method comprising:
providing a device layer of the IC chip;
forming a first sacrificial layer over the device layer;
forming a first patterned mask on the first sacrificial layer having a pattern for a first dielectric layer to surround the conductive element;
etching to pattern the first sacrificial layer using the first patterned mask;
forming the first dielectric layer within the patterned first sacrificial layer;
removing the patterned first sacrificial layer, leaving the first dielectric layer; and
forming the conductive element in a space vacated by the patterned first sacrificial layer.

2. The method of claim 1, wherein the first sacrificial layer is selected from the group consisting of: silicon dioxide (SiO₂), germano-silicate glass and germanium (Ge).

3. The method of claim 1, wherein the first sacrificial layer forming includes one of: spin applying the first sacrificial layer and baking, and vapor depositing the first sacrificial layer and annealing.

4. The method of claim 1, wherein in the case that the first sacrificial layer includes silicon dioxide (SiO₂) or germano-silicate glass, the removing includes using a dilute hydrofluoric (HF) acid.

5. The method of claim 1, wherein in the case that the first sacrificial layer includes germanium (Ge), the removing includes using a hydrogen peroxide (H₂O₂) solution.

6. The method of claim 1, wherein the patterned mask forming includes: forming a photoresist, patterning the photoresist with a mask and exposure tool, etching the photoresist, and stripping un-exposed photoresist.

7. The method of claim 1, wherein the first dielectric layer forming includes:
one of: spin applying, and vapor depositing the first dielectric layer;
annealing; and
planarizing.

8. The method of claim 1, wherein the conductive element forming includes: depositing a liner, depositing a metal, and planarizing.

9. The method of claim 8, wherein the liner is selected from the group consisting of: titanium nitride (TiN), tantalum nitride (TaN), tantalum (Ta) and ruthenium (Ru).

10. The method of claim 1, wherein the conductive element includes one of a laterally extending wire and a via.

11. The method of claim 1, wherein in the case that the conductive element includes a via and a laterally extending wire, the patterned first sacrificial layer is patterned for the via of the conductive element, further comprising prior to the patterned first sacrificial layer removing:
forming an etch stop layer over the patterned first sacrificial layer and the first dielectric layer;
forming a second sacrificial layer over the first sacrificial layer and the first dielectric layer;
forming a second patterned mask on the second sacrificial layer having a pattern for a second dielectric layer to surround the wire of the conductive element;
etching to pattern the second sacrificial layer using the second patterned mask;
forming the second dielectric layer within the patterned second sacrificial layer; and
removing the patterned second sacrificial layer; and
removing the etch stop layer,
wherein the conductive element forming further includes forming the conductive element in a space vacated by the patterned second sacrificial layer.

12. A structure comprising:
a conductive element positioned within a dielectric layer,
wherein the dielectric layer is free of damage at an edge thereof adjacent to the conductive element.

13. The structure of claim 12, wherein the conductive element includes at least one of: a laterally extending wire or a via.

14. A method of forming a conductive element for an integrated circuit (IC) chip, the method comprising:
forming a first sacrificial layer having a pattern therein for a first dielectric layer to surround the conductive element;
forming the first dielectric layer within the patterned first sacrificial layer;
removing the patterned first sacrificial layer, leaving the first dielectric layer; and
forming the conductive element in a space vacated by the patterned first sacrificial layer.

15. The method of claim 14, wherein the conductive element includes one of a laterally extending wire and a via.

16. The method of claim 14, wherein in the case that the conductive element includes a via and a laterally extending wire, the patterned first sacrificial layer is patterned for the via of the conductive element, further comprising prior to the patterned first sacrificial layer removing:
forming an etch stop layer over the patterned first sacrificial layer and the first dielectric layer;
forming a second sacrificial layer having a pattern therein for a second dielectric layer to surround a wire of the conductive element;
forming the second dielectric layer within the patterned second sacrificial layer; and
removing the patterned second sacrificial layer; and
removing the etch stop layer,
wherein the conductive element forming further includes forming the conductive element in a space vacated by the patterned second sacrificial layer.

17. The method of claim 16, wherein the first and second sacrificial layer are selected from the group consisting of: silicon dioxide (SiO₂), germano-silicate glass and germanium (Ge).

18. The method of claim 16, wherein the first and second sacrificial layer forming each include one of: a) spin applying the first sacrificial layer and baking, and b) vapor depositing the first sacrificial layer and annealing.

19. The method of claim 16, wherein in the case that the first sacrificial layer or the second sacrificial layer includes silicon dioxide (SiO₂) or germano-silicate glass, a respective removing includes using a dilute hydrofluoric (HF) acid.

20. The method of claim 16, wherein in the case that the first sacrificial layer or the second sacrificial layer includes germanium (Ge), a respective removing includes using a hydrogen peroxide (H₂O₂) solution.
